(19) United States
(12) Patent Application Publication
(10) Pub. No.: US 2017/0147758 A1
(43) Pub. Date: May 25, 2017

(54) SYSTEMS AND METHODS FOR MANAGING PATIENT-PROVIDER INTERACTIONS AND TIMELINES

(71) Applicant: Praxify Technologies, Inc., Palo Alto, CA (US)

(72) Inventors: Abhijit Manohar Gupta, Pune (IN); Mohan Rao, Pune (IN)

(21) Appl. No.: 15/425,426

(22) Filed: Feb. 6, 2017

Related U.S. Application Data
(63) Continuation of application No. PCT/IN2015/000317, filed on Aug. 7, 2015.

(30) Foreign Application Priority Data
Aug. 7, 2014 (IN) 2545/MUM/2014

(51) Int. Cl. G06F 19/00; H04L 29/08

(52) U.S. Cl. CPC G06F 19/322; H04L 67/10; G06F 19/327

(57) ABSTRACT

Digital assistant systems and methods include computerized displays that display timelines of healthcare instances based on date of the same. Timelines may display unique sets of healthcare instances based on selected nodes, filters, or other criteria such as allergies, prognosis, medications, or vitals. Digital assistant systems and methods provide single-page displays of timelines that can be sorted and filtered based on user engagement with the same. Additional information can be recorded through selection and filtering of timelines during specific interactions and times, associated with the recordation, through the single page.

### RELATED APPLICATIONS

This application claims priority under 35 U.S.C. §120 to, and is a continuation of, co-pending International Application PCT/IN2015/000317, filed Aug. 7, 2015 and designating the US, which claims priority to Indian Application 2545/MUM/2014, filed Aug. 7, 2014, such Indian Application also being claimed priority to under 35 U.S.C. §119. These Indian and International applications are incorporated by reference herein in their entireties, with the exception of any disclaimers and redefinitions, including statements of the present invention. U.S. Design application 29/500,027, filed Aug. 20, 2014, is further incorporated by reference herein in its entirety.

### BACKGROUND

Healthcare includes surgical procedures, examination procedures, diagnostic procedures, prognosis procedures, and several related activities. Medical professionals typically administer such healthcare while systematically documenting the patient's medical history and care over time, and potentially over multiple medical professionals, using a medical record, health record, medical chart, etc. Such medical records conventionally include notes and data relating to a patient's healthcare and client-patient interaction. For example, diagnoses, medical procedure history, vital signs and symptoms data, test results, drugs and medication data, prognoses, visit notes, insurance data, demographics, health and family histories, etc. may all be captured and recorded in a patient's medical record, together with existing personal health information such as name, birth date, blood type, and emergency contact; date of last physical; dates and results of tests and screenings; major illnesses and surgeries, with dates; lists of medicines, dosages and how long they are being taken; allergies; chronic diseases; history of illnesses in the patient's family, etc.

Laws and regulations, and well as economics, have encouraged adoption of computerized medical record technology worldwide. For example, in the US, the 2009 HITECH Act encourages and controls adoption of health information technology and creation of a nationwide network of electronic health records. Additionally, conservation efforts and increased cost of paper records have encouraged widespread adoption of electronic records and computerized, paperless systems and methods for medical records and medical practice management.

Maintaining complete and accurate medical records for use in healthcare administration aids the healthcare provider and patient from a medical and legal perspective. Conventionally, medical records are formulated, supplemented, and/or retrieved with patient management software (PMS) installed on a computer within a healthcare IT system. PMS is used to acquire medical information from a medical device in the treatment or diagnosis of a patient. Information from a PMS portal, such as an on-screen display of a medical record, can also be used as an aid to supplement the judgement and decision of a doctor. Once specific piece of healthcare IT includes mobile devices installed with PMS and specific interfaces with medical devices. For example, a tablet computing device, smart phone, and/or PDAs are often employed in healthcare IT with PMS.

### SUMMARY

Example embodiments and methods include digital assistant system for doctor-patient interactions and methods of using the same, including processor-controlled displays that determine doctor, patient, and/or identifier nodes and other sources of information for labelling and chronicling by a specific healthcare interaction and date of the same on a timeline. A user may then select individual subpopulations of encounters for display, based on selected nodes, filters, or other criteria. Example systems and methods thus provide single-page displays of healthcare interactions that can be sorted and filtered based on user engagement with a timeline, as well as recording additional information for the timeline associated with specific interactions and times through the single page.

### BRIEF DESCRIPTIONS OF THE DRAWINGS

Example embodiments will become more apparent by describing, in detail, the attached drawings, wherein like elements are represented by like reference numerals, which are given by way of illustration only and thus do not limit the example embodiments herein.

FIG. 1 is an illustration of an example embodiment patient management system.

FIG. 2 is an illustration of an example embodiment display generated by an example embodiment patient management system.

### DETAILED DESCRIPTION

This is a patent document, and general broad rules of construction should be applied when reading it. Everything described and shown in this document is an example of subject matter falling within the scope of the claims, appended below. Any specific structural and functional details disclosed herein are merely for purposes of describing how to make and use example embodiments. Several different embodiments not specifically disclosed herein may fall within the claim scope; as such, the claims may be embodied in many alternate forms and should not be construed as limited to only example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when element(s) are referred to in relation to one another, such as being “connected,” “coupled,” “mated,” “attached,” or “fixed” to another element(s), the relationship can be direct or with other intervening elements. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). Similarly, a term such as “connected” for communications purposes includes all variations of information exchange routes between two devices, including intermediary devices, networks, etc., connected wirelessly or not.

As used herein, the singular forms “a”, “an,” and “the” are intended to include both the singular and plural forms, unless the language explicitly indicates otherwise with terms like “only a single element.” It will be further understood that the terms “comprises,” “comprising,” “includes,” and/or “including,” when used herein, specify the presence of stated features, values, steps, operations, elements, and/or components, but do not themselves preclude the presence or addition of one or more other features, values, steps, operations, elements, components, and/or groups thereof.

It should also be noted that the structures and operations discussed below may occur out of the order described and/or noted in the figures. For example, two operations and/or figures shown in succession may in fact be executed concurrently or may be executed in the reverse order, depending upon the functionality/acts involved. Similarly, individual operations within example methods described below may be executed repetitively, individually or sequentially, so as to provide looping or other series of operations. It should be presumed that any embodiment having features and functionality described below, in any workable combination, falls within the scope of example embodiments.

The inventors have recognized that a paper trail exists in medical practice that is cumbersome to doctors, patients, and all other actors in the healthcare ecosystem. The paper trail is a deterrent for portability of information from one node of a healthcare environment to another. The inventors have recognized a need for coherence within, and seamless access for, all data related to a particular patient. Doctor-patient interactions should be electronically recordable and retrievable in an intuitive and user-friendly manner that reduced any need to type to speed recording and viewing. Retrieved information should be displayed in a limited space. The inventors have further recognized a need for recording medical information in terms of visits, lab tests, radiology tests, medications, diagnoses, procedures, prognoses, symptoms, and the like parameters, especially in the context of a time/date of the doctor-patient interaction. Example embodiments discussed below overcome these and other newly-recognized problems by allowing users to record and view electronic medical and health records.

The present invention is systems and methods for recording and displaying doctor-patient interactions in a single page with an interactive timeline. The present invention is not—and the inventors explicitly disclaim—scope over a bare transitory signal or an abstract idea per se. While transitory signals and general concepts of arranging human behavior, comparing information and using rulesets based thereon, and categorizing information are useable with or in the present invention, the present invention is limited to particular implementations of those signals and concepts to improve specific articles of health information technology, such as specifically-configured patient-management hardware and software. In contrast to the present invention, the few example embodiments and example methods discussed below illustrate just a subset of the variety of different configurations that can be used as and/or in connection with the present invention.

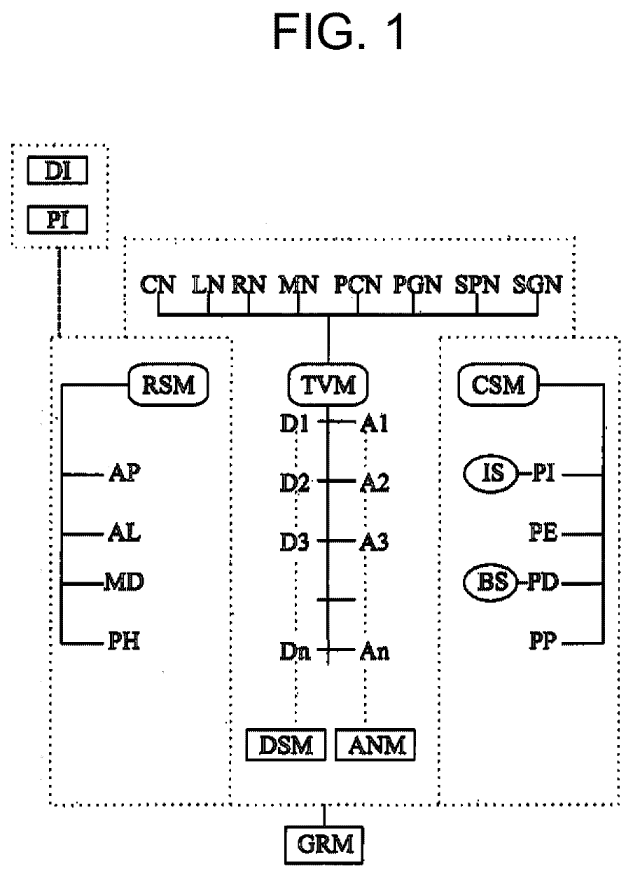

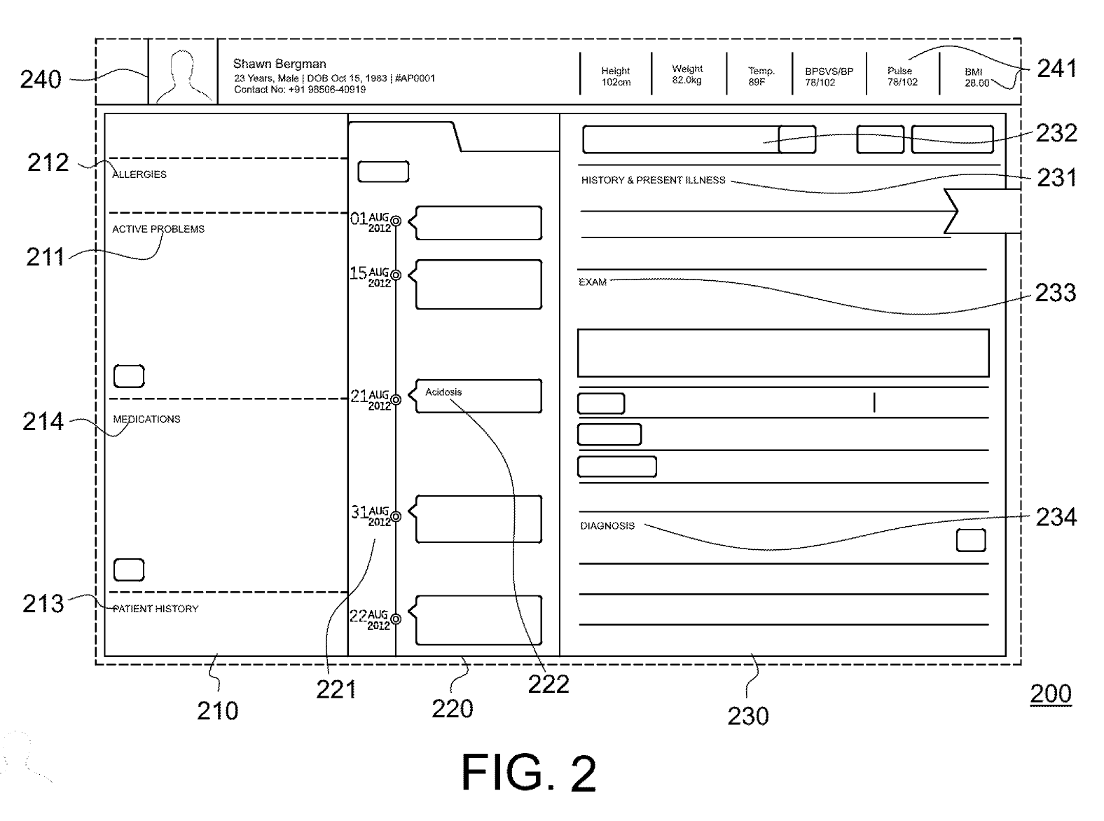

FIG. 1 illustrates a specially-configured hardware or software schematic that makes up an example embodiment patient management system 100. FIG. 2 illustrates an example graphical user interface and user interaction generated by example system 100 on a display such as a touchscreen or monitor. As such, it is understood that while example embodiments may be useable on computers including a display, user interaction with graphical user interface(s) is required in order to achieve certain functionalities and specific computational configurations discussed below.

As shown in FIG. 1, example embodiment patient management system 100 may include a doctor identifier DI. Doctor identifier D1 is configured to identify a doctor using system 100, for example, through registration including authentication wherein a doctor submits unique identifiers and/or credentials into the system. Upon recognition by DI, Example embodiment patient management system 100 is adapted to recognize and load the particular doctor's data.

Example embodiment system 100 may include a patient identifier PI configured to identify a patient using or otherwise stored in example embodiment system 100. For example, age, sex, date of birth, identification number, contact details, demographic details, blood type, photograph, insurance details, and the like may be stored in association with matching patients in PI, and such information may be retrievable through identifier PI.

Example embodiment system 100 may further include vital statistics recorder VS configured to record and display vital statistics of a patient. Recorder VS may be configured to display the patient vital statistics in a desired manner on the display. For example, height, weight, temperature, pulse, blood pressure, BMI, and the like may be recorded and displayed as patient vital statistics by recorder VS. As shown in FIG. 2, recorded vital statistics 241 may be displayed on a top-part 240 of a one-page display 200 by vital statistics recorder VS example embodiment system 100.

Example embodiment system 100 may further include a reference side controller RSM configured to control a one-screen, multi-fold, timeline-based relationship display that is responsive to gestures. Controller RSM may include an active problems' recorder AP configured to record and display active medical problems of a patient. Active problems recorder AP is configured to display active medical problems of the patient in a desired manner on a display. Recorder AP may record such problems at a first doctor-patient interaction and update the same at later interactions. Active problems may be stored in association with recorded or onset dates by recorder AP, such dates being displayable. As shown in FIG. 2, active problems 211 may be visible on a left hand side 210 of the one-page display by example embodiment system 100. A user may close an active problem after which it will not be visible on the one-page display.

Reference side controller RSM may include an allergies recorder AL configured to record and display allergies for a particular patient during a doctor-patient interaction. For example, as shown in FIG. 2, allergy information 212 stored in allergies recorder AL may be displayed on a left-hand side 210 of a one-page display by example embodiment system 100. Reference side controller RSM may further include a patient side history recorder PH configured to record and display patient history details. For example, as shown in FIG. 2, patient side history recorder PH may display patient side history 213 visible on a left-hand side 210 of the one-page display of example embodiment system 100. Reference side controller RSM may further include a medication data recorder MD configured to record and display current medication and medication history details for a patient. For example, as shown in FIG. 2, medication data 214 recorded by medication data recorder MD may be visible on a left-hand side 210 of the one-page display of example embodiment system 100.

Example embodiment patient management system 100 may also include chart side controller CSM configured to control additional aspects of the one-screen, multi-fold, timeline-based relationship display. Chart side controller CSM may include a present illness recorder PI configured to record and display a current illness or pathological state diagnosed during the doctor-patient interaction. For example, as shown in FIG. 2, a present illness recorder PI may be configured to display the present illness 231 on a right-had side 230 of the one-page display of example embodiment system 100. An illness searcher IS may be communicably connected with present illness recorder PI and configured to search for illness names and permit their selection and addition through recorder PI by the user during the doctor-patient interaction. For example, as shown in FIG. 2, present illness information 231 from recorder PI may be displayed on a right-hand side 230 of the one-page display of example embodiment system 100 in response to a search entered in illness searching field 232.

Chart side controller CSM may include a patient examination recorder PE configured to record and display examination proceedings, potentially on a per body part basis. A user may select a body part through recorder PE, and an associated sub-list may be provided depending on the selected body part. The user may then select examination information per body part, and information recorded with recorder PE may be displayed. For example, as shown in FIG. 2, a patient examination 233 may be displayed on a right-hand side 230 of the one-page display of example embodiment system 100. A notation option may also be provided to record additional notes pertinent to the doctor-patient interaction on the display.

Chart side controller CSM may include a patient diagnosis recorder PD configured to record and display diagnosis data during the doctor-patient interaction. A body part searcher BS may be communicably connected to patient diagnosis recorder PD to permit a user to search for body parts. When the user searches and selects a returned body part through searcher BS, an associated list of signs, symptoms, and/or diagnostic information may be displayed in a hierarchical manner through recorder PD. The user may select associated signs, symptoms, and/or diagnostic information while proceeding through the examination. The selection may be recorded and displayed. For example, as shown in FIG. 2, patient diagnosis 234 may be displayed on a right-hand side 230 of the one-page display of example embodiment system 100. A notation option may also be provided that is configured to record additional notes pertinent to the doctor-patient interaction on the display.

Chart side controller CSM may include patient prognosis recorder PP configured to record and/display prognosis data during the doctor-patient interaction. For example, recorder PP may display the patient prognosis on a right-hand side 230 of the one-page display of example embodiment system 100. A notation option may also be provided that is configured to record additional notes pertinent to the doctor-patient interaction on the display.

Example embodiment patient management system 100 may also include timeline view controller TVM configured to control additional aspects of the one-screen, multi-fold, timeline-based relationship display. Timeline view controller TVM may be configured to identify a doctor node, patient node, and identifier node in relation to a doctor-patient interaction. This relationship may include data relating to the doctor-patient interaction relative to an identifier node. Timeline view controller TVM may include a date stamper DSM configured to date-stamp the relationship. For example, as seen in FIG. 2, date stamper DSM may apply tag date stamps 221 to all doctor-patient interactions.

The identifier node can take on several different modes that control operation of timeline view controller TVM. For example, a doctor's clinic node CN may be the identifier node such that examination and diagnosis proceedings are recorded. Or, for example, laboratory test node LN may be the identifier node such that laboratory tests prescribed by the doctor to a patient and results thereof are recorded and viewed. Or, for example, radiology node RN may be the identifier node such that radiology reports prescribed by the doctor to a patient and results thereof are recorded and viewed. Or, for example, medications' node MN may be the identifier node such that medications prescribed by the doctor to a patient are recorded and viewed. Or, for example, procedure node PC may be the identifier node such that procedures prescribed by the doctor to a patient and results thereof are recorded and viewed. Or, for example, prognosis node PGN may be the identifier node such that prognosis data jotted by a doctor is recorded and viewed. Or, for example, diagnosis node DGN may be the identifier node such that diagnosis data jotted by a doctor is recorded and viewed. Or, for example, symptoms node SPN may be the identifier node such that symptoms noted by the doctor in relation to a patient are recorded and viewed. Or, for example signs node SGN may be the identifier node such that signs noted by the doctor in relation to a patient are recorded and viewed.

The identifier node may further take on several different forms to control operation of timeline view controller TVM in example embodiment system 100. For example, the identifier node may be an active problems node that records active problems by a doctor and uses the same for configuration of a time-line, a past problems that records past problems by a doctor and uses the same for configuration of a time-line, an exodus data node that records and displays exodus data of the patient, a genomic data node that records and views genomic data of the patient, a financial information node that records and displays financial information of the patient, and/or a vitals display node that records and displays vitals information of the patient.

Several different types of data for a doctor-patient interaction may be tagged and stored in example embodiment system 100. Data may be date-stamped and/or time-stamped. Filters may be coupled with each of the nodes so that selection of a node displays corresponding doctor-patient interaction data only according to the selected node and applied filter item. Filters may further permit selection of patient identities and a relationship between a doctor and each of the patients based on a common identifier node or a selectable item.

For example, if an identifier node selected is a medication node, a timeline of doctor-patient interactions and corresponding medications may be displayed on a time-line. If a filter for a particular medicine is applied, the timeline for the doctor-patient interactions may display only the selected medicine item, for example, specific times the medicine was provided. Or, for example, if only an identifier node such as a medicine is selected along with a doctor, then the time-line may display with patients prescribed the selected medicine, thereby allowing the user to see a timeline showing when the medicine was prescribed for all patients over a period of time.

Time-line display may include an annotator ANM configured to annotate, such as with annotations 222, doctor-patient interactions correlating to any applied node(s) and tags. For example, as seen in FIG. 2, annotations 222 may be visible on the displayed time-line, and selection of an annotation may activate chart side controller CSM to visualize and/or populate relevant display fields in correlation with the selected annotation. The same selection and corresponding visualization may be achieved with a displayed date stamp, thereby providing an interactive time-line view.

A displayed time-line can be sorted and/or filtered in several ways. For example, selection of a filter can generate a time-line including doctor-patient interaction(s) chronicled in connection with a selected variable such as treatment plans, diagnoses, prognoses, medications, tests, results, outpatient classification, inpatient classification, etc. Or, for example, each doctor-patient interaction may have context information entered and associated with the interaction. Such context information may be auto-set or selected by a user. Context can be selected from, for example, location, doctor's preference, patient's preference, role of a user, or the like. In this way, each timeline may be displayed in connection with only a selected context. Contexts for timeline display may be selected through auto-learning based on a user's past behavior, based on a user's role, and/or by a user-selection.

Example embodiment patient management system 100 may also include a mapper configured to map a first time-line on to a second time-line. The first time-line may be, for example, a first doctor-patient interaction in relation to a first patient, and the second time-line may be a second doctor-patient interaction in relation to a second patient, where the two timelines have a same identifier node. The user may select the mapping option by the mapper in order to understand patterns or trends among different patients, for example.

Example embodiment patient management system 100 may also include a gesture recognition engine GRM configured to identify a gesture that actuates functionality in system 100, such as time-line view controller TVM. For example, as seen in FIG. 2, time-line view controller TVM may display timeline 220 between information displayed by reference side controller RSM on the operative left side 210 and by chart side controller CSM on the operative right side 230 of an output display. Information in a time-line view may not be visible at all times but is displayed in response to a gesture or other input. When the time-line view becomes visible, reference side controller RSM may move and position the reference side view closer to the operative left 210 of the display while chart side controller CSM moves and positions the chart side view closer to the operative right 230 of the display. Time-line view controller TVM may then display the time-line 220 interposed between the left-side reference side view 210 and the right-side chart side view 230 as shown in FIG. 2. In response to a further gesture or other input, the timeline view can be displayed in a variety of ways based on filtering, sorting, and/or annotation. Thus, the time-line of a doctor-patient interaction can be viewed in terms of chronology of visits, chronology of diagnosis data, chronology of prognosis data, chronology of signs' data, chronology of symptoms' data, chronology of tests' data, chronology of laboratory results' data, chronology of medication related data, etc.

The various controllers, annotators, stampers, and related features of FIG. 1 are specifically-configured computer processor(s) and the various nodes of FIG. 1 are information sources, such as linked databases, that achieve the functionality of the GUI of FIG. 2 through hardware and software. FIG. 1 in its entirety may be executed by a single computer processor and attendant memory and bus, connected to an input-receptive display, or various components thereof may be executed by distinct processors, memories, servers, etc. distributed remotely from each other.

Some example methods being described here and in the incorporated documents, it is understood that one or more example methods may be used in combination and/or repetitively to produce multiple options and functionalities for subscribers. Example methods may be performed by properly programming or hardware configuring notification networks to receive healthcare information and subscriber information and act in accordance with example methods. Similarly, example methods may be embodied on non-transitory computer-readable media that directly instruct computer processors to execute example methods and/or, through installation in persistent memory, configure general-purpose computers connected to subscribers and healthcare information sources into specific healthcare notification networks that execute example methods.

The data, in each of the components, means, modules, mechanisms, units, devices of example systems and methods may be ‘encrypted’ and suitably ‘decrypted’ when required. Encryption can be accomplished using any encryption technology, such as the process of converting digital information into a new form using a key or a code or a program, wherein the new form is unintelligible or indecipherable to a user or a thief or a hacker or a spammer. The term ‘encryption’ includes encoding, compressing, or any other translating of the digital content. The encryption of the digital media content can be performed in accordance with any technology including utilizing an encryption algorithm. The encryption algorithm utilized is not hardware dependent and may change depending on the digital content. For example, a different algorithm may be utilized for different websites or programs. The term ‘encryption’ further includes one or more aspects of authentication, entitlement, data integrity, access control, confidentiality, segmentation, information control, and combinations thereof.

These example systems and methods can be made accessible through a portal or an interface which is a part of, or may be connected to, an internal network or an external network, such as the Internet or any similar portal. The portals or interfaces are accessed by one or more of users through an electronic device, whereby the user may send and receive data to the portal or interface which gets stored in at least one memory device or at least one data storage device or at least one server, and utilizes at least one processing unit. The portal or interface in combination with one or more of memory device, data storage device, processing unit and serves, form an embedded computing setup, and may be used by, or used in, one or more of a non-transitory, computer readable medium. In at least one embodiment, the embedded computing setup and optionally one or more of a non-transitory, computer readable medium, in relation with, and in combination with the said portal or interface forms one of the systems of the invention. Typical examples of a portal or interface may be selected from but is not limited to a website, an executable software program or a software application.

The systems and methods may simultaneously involve more than one user or more than one data storage device or more than one host server or any combination thereof. In at least one embodiment, one or more user can be blocked or denied access to one or more of the aspects of the invention.

A user may provide user input through any suitable input device or input mechanism such as but not limited to a keyboard, a mouse, a joystick, a touchpad, a virtual keyboard, a virtual data entry user interface, a virtual dial pad, a software or a program, a scanner, a remote device, a microphone, a webcam, a camera, a fingerprint scanner, pointing stick, etc.

Example systems and methods can be practiced using computer processor-based devices which may be connected to one or more of other electronic device with wires or wirelessly which may use technologies such as but not limited to, NFC, Bluetooth, Wi-Fi, Wimax. This will also extend to use of the aforesaid technologies to provide an authentication key or access key or electronic device based unique key or any combination thereof.

The described embodiments may be implemented as a system, method, apparatus or article of manufacture using standard programming and/or engineering techniques related to software, firmware, hardware, or any combination thereof. The described operations may be implemented as code maintained in a “non-transitory, computer readable medium”, where a processor may read and execute the code from the non-transitory, computer readable medium. A non-transitory, computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. The code implementing the described operations may further be implemented in hardware logic (e.g., an integrated circuit chip, Programmable Gate Array (PGA), Application Specific Integrated Circuit (ASIC), etc.). The term network means a system allowing interaction between two or more electronic devices, and includes any form of inter/intra enterprise environment such as the world wide web, Local Area Network (LAN), Wide Area Network (WAN), Storage Area Network (SAN) or any form of Intranet.

While code implementing the described operations may be transmitted in “transmission signals,” where transmission signals may propagate through space or through a transmission media, such as an optical fiber, copper wire, etc. in the form of a wireless signal, satellite transmission, radio waves, infrared signals, Bluetooth, etc., any claimed code or logic is stored in hardware or a non-transitory, computer readable medium at the receiving and transmitting stations or devices. Further, a device in which the code implementing the described embodiments of operations is encoded may comprise a non-transitory, computer readable medium or hardware logic. Of course, those skilled in the art will recognize that many modifications may be made to this configuration without departing from the scope of the present invention, and that the article of manufacture may comprise suitable information bearing medium known in the art.

Example systems and methods can use properly configured personal computers, tablet computers, mobile phones, laptop computers, palmtops, portable media players, and personal digital assistants. In an embodiment, the computer readable medium data storage unit or data storage device, or input file F may be selected from a set of but not limited to USB flash drive (pen drive), memory card, optical data storage discs, hard disk drive, magnetic disk, magnetic tape data storage device, data server and molecular memory.

Some example methods being described here and in the incorporated documents, it is understood that one or more example methods may be used in combination and/or repetitively to produce multiple options and functionalities for subscribers. Example methods may be performed by properly programming or hardware configuring systems for casting analysis to receive casting designs and act in accordance with example methods. Similarly, example methods may be embodied on non-transitory computer-readable media that directly instruct computer processors to execute example methods and/or, through installation in persistent memory, configure general-purpose computers connected to subscribers and healthcare information sources into specific healthcare notification networks that execute example methods.

Example methods and embodiments thus being described, it will be appreciated by one skilled in the art that example embodiments may be varied through routine experimentation and without further inventive activity. For example, although gestures are used in example embodiments to trigger GUI-altering functionality, it is understood that other inputs, such as from a mouse, may also achieve such functionality. Variations are not to be regarded as departure from the spirit and scope of the exemplary embodiments, and all such modifications as would be obvious to one skilled in the art are intended to be included within the scope of the following claims.

What is claimed is:

1. A digital assistant system for doctor-patient interactions, the system comprising:
a display; and
a computer processor configured to,
determine a doctor node,
determine a patient node,
determine an identifier node,
identify the doctor node, patient node, and identifier node in relation to doctor-patient interactions in a date-stamped manner,
display the doctor node, patient node, identifier node, and doctor-patient interactions in a timeline based on the date stamps, and
display, in the timeline, only a subset of the doctor-patient interactions in response to a user selection of at least one of the doctor node, patient node, and identifier node corresponding to the subset of doctor-patient interactions.

2. The system of claim 1, wherein the processor is further configured to provide current patient-specific information and illness-specific information.

3. The system of claim 2, wherein the processor is further configured to,
provide an illness-specific field for receipt of data, and
display the illness-specific information based on the data received from the illness-specific field.

4. The system of claim 3, wherein the processor is further configured to,
display an annotation on all of the subset of doctor-patient interactions on the timeline in response to a selection of the annotation from the timeline, and
populate a chart side field based on the annotation so as to display an interactive annotated and filtered timeline view.

5. The system of claim 1, wherein the processor is further configured to,
display an annotation on all of the subset of doctor-patient interactions on the timeline, and
display, in the timeline, only a different subset of the doctor-patient interactions in response to a user selection of the annotation corresponding to the different subset of doctor-patient interactions.

6. The system of claim 5, wherein the processor is further configured to populate a relevant chart side field in correlation with a selected date stamp on the user selection of the annotation so as to display an interactive timeline view.

7. The system of claim 1, wherein the processor is further configured to establish a context for each of the doctor-patient interactions.

8. The system of claim 1, wherein the processor is further configured to,
establish a context for each of the doctor-patient interactions, and
synchronize a selected context so that the timeline is displayed in a context of a selected context.

9. The system of claim 1, wherein the processor is further configured to,
recognize a gesture and display the timeline in response to the gesture, and
move a reference side on the display to an operative left, move a chart side view on the display to an operative right, and display the timeline between the reference side and the chart side view.

10. The system of claim 1, wherein the processor is further configured to recognize a gesture and display the timeline in a filtered manner based on the gesture.

11. The system of claim 1, wherein the timeline includes clickable links configured with annotations.

12. The system of claim 1, wherein the processor is further configured to tag date stamps to all the doctor-patient interactions.

13. The system of claim 1, wherein the processor is further configured to display the timeline based on at least one of an input sort parameter and a filter.

14. The system of claim 1, wherein the identifier node is at least one of a doctor clinic node storing examination and diagnosis proceedings, a laboratory test node storing laboratory tests prescribed by a doctor and results thereof, a radiology node storing radiology reports prescribed by a doctor and results thereof, a medications node storing medications prescribed by the doctor, a procedures node storing procedures prescribed by a doctor and results thereof, a prognosis node storing prognosis data jotted by a doctor, a diagnosis node storing diagnosis data jotted by a doctor, a symptoms node storing symptoms noted by a doctor in relation to a patient, a signs node storing signs noted by a doctor in relation to a patient, an active problems node storing active problems recorded by a doctor and used in displaying the timeline, a past problems node storing past problems recorded by a doctor and used in displaying the timeline, an exodus data node storing exodus data for a patient, a genomic data node storing genomic data of a patient, a financial information node storing financial data of a patient, and a vitals node storing vitals data of a patient.

15. The system of claim 1, wherein the processor is further configured to,
record vital statistics of a patient, and
display the vital statistics on the display.

16. The system of claim 1, wherein the processor is further configured to,
record active medical problems of a patient, and
display the active problems on the display.

17. The system of claim 1, wherein the processor is further configured to,
record active medical problems of a patient, and
display the active problems by date on the display.

18. The system of claim 1, wherein the processor is further configured to,
record allergies of a patient, and
display the allergies on the display.

19. The system of claim 1, wherein the processor is further configured to,
record patient history, and
display the patient history on the display.

20. The system of claim 1, wherein the processor is further configured to,
record medication history of a patient, and
display the medication history on the display.

21. The system of claim 1, wherein the processor is further configured to,
record presently-diagnosed illnesses of a patient, and
display the illnesses on the display.

22. The system of claim 21, wherein the processor is further configured to search for illness names so that they can be selected and recorded by a doctor as the illness.

23. The system of claim 1, wherein the processor is further configured to record examination proceedings per body part entered by a user.

24. The system of claim 23, wherein the processor is further configured to populate an associated sub-list based on a selected body part, wherein the examination proceedings are selected from the sub-list.

25. The system of claim 23, wherein the processor is further configured to permit the user to take down additional pertinent notes.

26. The system of claim 1, wherein the processor is further configured to,
record diagnosis data, and
display the diagnosis data on the display.

27. The system of claim 26, wherein the processor is further configured to,
search for body parts based on the diagnosis data, and
display a list of signs, symptoms, and/or diagnostic information in a hierarchical manner in connection with the body parts for selection.

28. The system of claim 1, wherein the processor is further configured to,
record diagnosis data, and
enable a doctor to take down additional pertinent notes.

29. The system of claim 1, wherein the processor is further configured to,
record prognosis data, and
display the prognosis data on the display.

30. The system of claim 29, wherein the processor is further configured to enable a doctor to take down additional pertinent notes.

31. The system of claim 1, wherein the subset of the doctor-patient interactions is all only in correlation with a selected node and also only in correlation with an applied filter.

32. The system of claim 1, wherein the processor is further configured to,
select a plurality of patient identities, and
select a relationship between a doctor node and a plurality of patient nodes based on a common identifier node.

33. The system of claim 1, wherein the processor is further configured to,
select a plurality of patient identities, and
select a relationship between a doctor node and a plurality of patient nodes based on a selectable item.

34. The system of claim 1, wherein the processor is further configured to display one of the doctor-patient interactions based on selectable items in a filter.

35. The system of claim 1, wherein the processor is further configured to filter the timeline so that the timeline includes a doctor-patient interaction chronicled based on at least one of treatment plans data, diagnoses data, prognoses data, medications data, tests data, results data, outpatient classification data, inpatient classification data, exodus data, genomic data, financial information data, and vitals data.

36. The system of claim 1, wherein the processor is further configured to map a second timeline on to the timeline, wherein the timeline is a first doctor-patient interaction in relation to a first patient, and wherein the second timeline is a second doctor-patient interaction in relation to a second patient having identifier node is common with the first patient.

37. A method for managing doctor-patient interactions with a computer processor-based display, the method comprising:
determining, with the computer processor, a doctor node;
determining, with the computer processor, a patient node;
determining, with the computer processor, an identifier node;
identifying, with the computer processor, the doctor node, patient node, and identifier node in relation to doctor-patient interactions in a date-stamped manner;
displaying, on the display, the doctor node, patient node, identifier node, and doctor-patient interactions in a timeline based on the date stamps; and
displaying, in the timeline, only a subset of the doctor-patient interactions in response to a user selection of at least one of the doctor node, patient node, and identifier node corresponding to the subset of doctor-patient interactions.

38. The method of claim 37, further comprising:
providing, with the computer processor, current patient-specific information and illness-specific information.

39. The method of claim 37, further comprising:
providing, with the computer processor, an illness-specific field for receipt of data; and
displaying, on the display, the illness-specific information based on the data received from the illness-specific field.

40. The method of claim 39, further comprising:
displaying, on the display, an annotation on all of the subset of doctor-patient interactions on the timeline in response to a selection of the annotation from the timeline; and
populating a chart side field based on the annotation so as to display an interactive annotated and filtered timeline view.

41. The method of claim 37, further comprising:
displaying, on the display, an annotation on all of the subset of doctor-patient interactions on the timeline; and
displaying, in the timeline, only a different subset of the doctor-patient interactions in response to a user selection of the annotation corresponding to the different subset of doctor-patient interactions.

42. The method of claim 41, further comprising:
populating a relevant chart side field in correlation with a selected date stamp on the user selection of the annotation so as to display an interactive timeline view.

43. The method of claim 37, further comprising:
establishing, with the computer processor, a context for each of the doctor-patient interactions.

44. The method of claim 37, further comprising:
establishing, with the computer processor, a context for each of the doctor-patient interactions, and
synchronizing, with the computer processor, a selected context so that the timeline is displayed in a context of a selected context.

45. The method of claim 37, further comprising:
recognizing, with the computer processor, a gesture and display the timeline in response to the gesture, and
moving, with the computer processor, a reference side on the display to an operative left, move a chart side view on the display to an operative right, and display the timeline between the reference side and the chart side view.

46. The method of claim 37, further comprising:
recognizing, with the computer processor, a gesture and display the timeline in a filtered manner based on the gesture.

47. The method of claim 37, wherein the timeline includes clickable links configured with annotations.

48. The method of claim 37, further comprising:
tagging, with the computer processor, date stamps to all the doctor-patient interactions.

49. The method of claim 37, further comprising:
displaying, with the computer processor, the timeline based on at least one of an input sort parameter and a filter.

50. The method of claim 37, wherein the identifier node is at least one of a doctor clinic node storing examination and diagnosis proceedings, a laboratory test node storing laboratory tests prescribed by a doctor and results thereof, a radiology node storing radiology reports prescribed by a doctor and results thereof, a medications node storing medications prescribed by the doctor, a procedures node storing procedures prescribed by a doctor and results thereof, a prognosis node storing prognosis data jotted by a doctor, a diagnosis node storing diagnosis data jotted by a doctor, a symptoms node storing symptoms noted by a doctor in relation to a patient, a signs node storing signs noted by a doctor in relation to a patient, an active problems node storing active problems recorded by a doctor and used in displaying the timeline, a past problems node storing past problems recorded by a doctor and used in displaying the timeline, an exodus data node storing exodus data for a patient, a genomic data node storing genomic data of a patient, a financial information node storing financial data of a patient, and a vitals node storing vitals data of a patient.

51. The method of claim 37, further comprising:
recording, with the computer processor, vital statistics of a patient; and
displaying, on the display, the vital statistics.

52. The method of claim 37, further comprising:
recording, with the computer processor, active medical problems of a patient; and
displaying, on the display, the active problems.

53. The method of claim 37, further comprising:
recording, with the computer processor, active medical problems of a patient; and
displaying the active problems by date on the display.

54. The method of claim 37, further comprising:
recording, with the computer processor, allergies of a patient; and
displaying the allergies on the display.

55. The method of claim 37, further comprising:
recording, with the computer processor, patient history; and
displaying the patient history on the display.

56. The method of claim 37, further comprising:
recording, with the computer processor, medication history of a patient; and
displaying the medication history on the display.

57. The method of claim 37, further comprising:
recording, with the computer processor, presently-diagnosed illnesses of a patient; and
displaying the illnesses on the display.

58. The method of claim 57, further comprising:
searching, with the computer processor, for illness names so that they can be selected and recorded by a doctor as the illness.

59. The method of claim 37, further comprising:
recording, with the computer processor, examination proceedings per body part entered by a user.

60. The method of claim 59, further comprising:
populating, with the computer processor, an associated sub-list based on a selected body part, wherein the examination proceedings are selected from the sub-list.

61. The method of claim 60, further comprising:
permitting, with the computer processor, the user to take down additional pertinent notes.

62. The method of claim 37, further comprising:
recording, with the computer processor, diagnosis data; and
displaying the diagnosis data on the display.

63. The method of claim 62, further comprising:
searching, with the computer processor, for body parts based on the diagnosis data; and
displaying, on the display, a list of signs, symptoms, and/or diagnostic information in a hierarchical manner in connection with the body parts for selection.

64. The method of claim 37, further comprising:
recording, with the computer processor, diagnosis data; and
enabling, with the computer processor, a doctor to take down additional pertinent notes.

65. The method of claim 37, further comprising:
recording, with the computer processor, prognosis data; and
displaying the prognosis data on the display.

66. The method of claim 65, further comprising:
enabling, with the computer processor, a doctor to take down additional pertinent notes.

67. The method of claim 37, wherein the subset of the doctor-patient interactions is all only in correlation with a selected node and also only in correlation with an applied filter.

68. The method of claim 37, further comprising:
selecting, with the computer processor, a plurality of patient identities; and
selecting, with the computer processor, a relationship between a doctor node and a plurality of patient nodes based on a common identifier node.

69. The method of claim 37, further comprising:
selecting, with the computer processor, a plurality of patient identities; and
selecting, with the computer processor, a relationship between a doctor node and a plurality of patient nodes based on a selectable item.

70. The method of claim 37, further comprising:
displaying one of the doctor-patient interactions based on selectable items in a filter on the display.

71. The method of claim 37, further comprising:
filtering, with the computer processor, the timeline so that the timeline includes a doctor-patient interaction chronicled based on at least one of treatment plans data, diagnoses data, prognoses data, medications data, tests data, results data, outpatient classification data, inpatient classification data, exodus data, genomic data, financial information data, and vitals data.

72. The method of claim 37, further comprising:
mapping, with the computer processor, a second timeline on to the timeline, wherein the timeline is a first doctor-patient interaction in relation to a first patient, and wherein the second timeline is a second doctor-patient interaction in relation to a second patient having identifier node is common with the first patient.
